(19) United States
(12) Patent Application Publication
(10) Pub. No.: US 2016/0134943 A1
(43) Pub. Date: May 12, 2016

(54) ELECTRONIC DEVICE AND METHOD OF PROCESSING DISPLAY SCREEN

(71) Applicants: Kabushiki Kaisha Toshiba, Tokyo (JP); Toshiba Lifestyle Products & Services Corporation, Tokyo (JP)

(72) Inventor: Takanobu Sasaki, Kumagaya Saitama (JP)

(21) Appl. No.: 14/535,151

(22) Filed: Nov. 6, 2014

(51) Int. Cl. H04N 21/485

(52) U.S. Cl. CPC H04N 21/4854; H04N 21/4852

(57) ABSTRACT

According to one embodiment, an electronic device comprises a receiver configured to accept an instruction to display or change a menu screen, and an identifier recorder configured to record, when the menu screen is displayed or changed under the instruction, an identifier of the displayed or changed menu screen.

### FIELD

Embodiments described herein relate generally to an electronic device and a method of processing a display screen.

### BACKGROUND

Recently, as a result of increased functionality of video display devices, users are now able to adjust the set value of the display function of each of a plurality of items such as brightness, color gamut, and indoor conditions. The display function has diversified according to video display methods and content to be reproduced. Therefore, the user must press a select key and an execute key many times and move down a menu hierarchy in order to display an operation menu of an item to be adjusted. For this reason, a conventional video display device has a problem that operations of pressing the select key and the execute key should be repeated to readjust items last adjusted by the user.

### BRIEF DESCRIPTION OF THE DRAWING

A general architecture that implements the various features of the embodiments will now be described with reference to the drawings. The drawings and the associated descriptions are provided to illustrate the embodiments and not to limit the scope of the invention.

FIG. 1 is a block diagram showing a configuration of a system to which an electronic device of a first embodiment is applied.

FIG. 2A is a table showing an example of a menu screen 2 or a setting change screen for adjusting the characteristics of video, audio, etc.

FIG. 2B is a table showing an example of the menu screen 2 or the setting change screen for adjusting the characteristics of video, audio, etc.

FIG. 2C is a table showing an example of the menu screen 2 or the setting change screen for adjusting characteristics of video, audio, etc.

FIG. 3 is a table schematically showing a state of a memory in which an item name, a set value and an identifier of the menu screen 2 last displayed are recorded per register.

FIG. 4 is a diagram schematically showing a relationship between a high tone setting screen and a register in the memory corresponding to the high tone setting.

FIG. 5 is a block diagram showing a flow of signal processing from receiving an instruction by a receiver.

FIG. 6 is a block diagram showing a configuration of a system to which an electronic device of a second embodiment is applied.

FIG. 7 is a block diagram showing a flow of signal processing from receiving an instruction by a receiver.

### DETAILED DESCRIPTION

Various embodiments will be described hereinafter with reference to the accompanying drawings. In general, according to one embodiment, an electronic device comprises a receiver configured to accept an instruction to display or change a menu screen, and an identifier recorder configured to record, when the menu screen is displayed or changed under the instruction, an identifier of the displayed or changed menu screen.

### First Embodiment

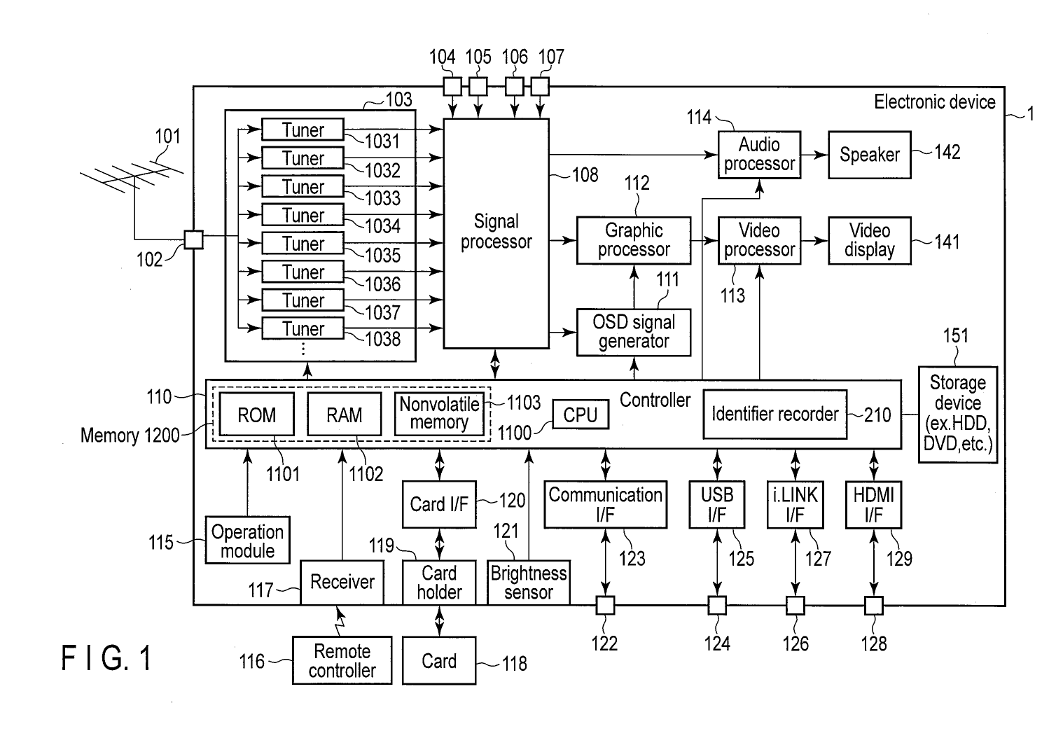

FIG. 1 is a view showing a configuration of an electronic device 1 of a first embodiment.

As shown in FIG. 1, the electronic device 1 of the first embodiment comprises an antenna 101, an input terminal 102, a tuner module 103, external input terminals 104 to 107, a signal processor 108, a controller 110, an on-screen display (OSD) signal generator 111, a graphics processor 112, a video processor 113, an audio processor 114, an operation module 115, a receiver 117, a card holder 119, a card interface 120, a brightness sensor 121, a LAN terminal 122, a communication interface 123, a USB terminal 124, a USB interface 125, an iLINK terminal 126, an iLINK interface 127, an HDMI (Registered Trademark) terminal 128, an HDMI interface 129, a video display 141, a speaker 142, a storage device 151, and an identifier recorder 210. The identifier recorder 210 may be provided integrally with the controller 110 as shown in FIG. 1, or may be provided independently.

The tuner portion 103 comprises tuners 1031 to 1038 for terrestrial digital television broadcasting, and further comprises tuners for BS/CS digital television broadcasting. A program guide corresponding to the terrestrial digital television broadcasting can be received and displayed by the tuners 1031 to 1038 for the terrestrial digital television broadcasting. A program guide corresponding to the BS/CS digital television broadcasting can be also received and displayed by the tuners for the BS/CS digital television broadcasting.

In the present embodiment, the electronic device 1 comprises the video display 141 and the speaker 142 as shown in FIG. 1. However, the electronic device 1 is not limited to such a configuration. For example, the electronic device 1 may have a configuration excluding the video display 141 and the speaker 142. That is, the electronic device 1 may be connected to the video display 141 and the speaker 142 via connecting means such as an HDMI.

In the present embodiment, the electronic device 1 comprises the storage device 151 as shown in FIG. 1. However, the electronic device 1 is not limited to such a configuration. For example, the electronic device 1 may have a configuration excluding the storage device 151. That is, the electronic device 1 may be connected to external storage (an HDD, etc.) via connecting means such as the USB terminal 124 and the USB interface 125.

In the present embodiment, the electronic device 1 comprises the plurality of tuners as shown in FIG. 1. However, the electronic device 1 is not limited to such a configuration. For example, the electronic device 1 may have a configuration excluding the plurality of tuners. In this case, for example, the electronic device 1 may be configured to receive Internet Protocol (IP) broadcasting via the LAN terminal 122, and play back and record programs corresponding to a plurality of channels of the IP broadcasting.

The electronic device 1 is hereinafter described in detail.

Terrestrial digital television broadcasting signals received by the antenna 101 for receiving the terrestrial broadcasting are supplied to the tuners 1031 to 1038 via the input terminal 102, and digital television broadcasting signals of desired channels are selected by signal processors for the terrestrial digital television broadcasting of the tuners 1031 to 1038. Then, the plurality of digital television broadcasting signals selected by the tuners 1031 to 1038 are supplied to the signal processor 108 and demodulated into digital video signals and digital audio signals.

The signal processor 108 selectively executes predetermined digital signal processing for the digital video signals and the digital audio signals, and outputs the signals to the graphic processor 112 and the audio processor 114.

For example, four input terminals 104 to 107 are connected to the signal processor 108. Each of the input terminals 104 to 107 allows analog video signals and analog audio signals to be input from the outside of the electronic device 1.

The signal processor 108 selectively digitizes the analog video signals and the analog audio signals supplied from each of the input terminals 104 to 107, executes predetermined digital signal processing for the digitized video signals and the digitized audio signals, and then outputs the signals to the graphic processor 112 and the audio processor 114.

The graphic processor 112 has a function of superimposing OSD signals generated by the OSD signal generator 111 on the digital video signals supplied from the signal processor 108 and outputting the signals. The graphic processor 112 can selectively output the output video signals of the signal processor 108 and the output OSD signals of the OSD signal processor 111, and output the signals in combination such that each of the outputs constitutes a half of the screen.

The digital video signals output from the graphic processor 112 are supplied to the video processor 113. The video signals processed by the video processor 113 are supplied to the video display 141. The video display 141 displays a picture based on the video signals.

The audio processor 114 converts the input digital audio signals into analog audio signals in a format reproducible by the speaker 142, and then outputs the converted signals to the speaker 142 and performs audio reproduction.

All operations of the electronic device 1 including various reception operations described above are comprehensively controlled by the controller 110. The controller 110 comprises a central processing unit (CPU) 1100, etc. The controller 110 accepts operation information (various instructions) from the operation module 115 or operation information (various instructions) received from a remote controller 116 via the receiver 117, and controls each module, etc., such that the content of the operation is reflected on the control. The receiver 117 and the remote controller 116 may transmit and receive operation signals by wireless communication using radio waves, etc., or may use infrared radiation. The receiver 117 accepts an instruction to display a menu screen 2 or change the menu screen 2 (i.e., decide a menu item and display the next menu screen 2) from the remote controller 116.

The controller 110 comprises a memory 1200. The memory 1200 comprises, for example, a read-only memory (ROM) 1101 which stores a control program executed by the CPU 1100, a random access memory (RAM) 1102 which provides the CPU 1100 with a work area, and a nonvolatile memory 1103 to store various types of setting information, control information, etc. For example, when the menu screen 2 is displayed or changed under the instruction from the remote controller 116, the RAM 1102 or the nonvolatile memory 1103 records an identifier of the displayed or changed menu screen 2 by the identifier recorder 110. The identifier may be recorded by the CPU 1100 by means of the program stored in the ROM 1101 instead of the identifier recorder 110.

The controller 110 is connected to the card holder 119 to which a memory card 118 can be attached via the card interface 120. The controller 110 can thereby transmit information to and receive information from the memory card 118 attached to the card holder 119 via the card interface 120.

The controller 110 is also connected to the LAN terminal 122 via the communication interface 123. The controller 110 can thereby transmit information to and receive information from a LAN-compatible device connected to the LAN terminal 122 via the communication interface 123. In this case, the controller 110 has a dynamic host configuration protocol (DHCP) server function, and controls the LAN-compatible device connected to the LAN terminal 122 by assigning an IP address to the LAN-compatible device. The controller 110 can also communicate with a data server via the communication interface 123.

The controller 110 is also connected to the HDMI terminal 128 via the HDMI interface 129. The controller 110 can thereby transmit information to and receive information from an HDMI-compatible device connected to the HDMI terminal 128 via the HDMI interface 129.

The controller 110 is also connected to the USB terminal 124 via the USB interface 125. The controller 110 can thereby transmit information to and receive information from a USB-compatible device connected to the USB terminal 124 via the USB interface 125.

The controller 110 is also connected to the iLINK terminal 126 via the iLINK interface 127. The controller 110 can thereby transmit information to and receive information from an iLINK-compatible device connected to the iLINK terminal 126 via the iLINK interface 127.

The controller 110 is configured to receive a brightness detection signal from the brightness sensor 121. The controller 110 can thereby control backlight and picture brightness, etc., based on the brightness detection signal.

The controller 110 can also control a recording operation to record broadcasting signals selected and descrambled by the tuner module 103 in the storage device 151 or the external storage (HDD, etc.) connected via the LAN terminal 122 or the USB terminal 124. As described above, since the tuner module 103 comprises the plurality of tuners 1031 to 1038, the electronic device 1 can record and display programs of a plurality of channels at the same time. The electronic device 1 also has a function of authenticating scrambled broadcasting.

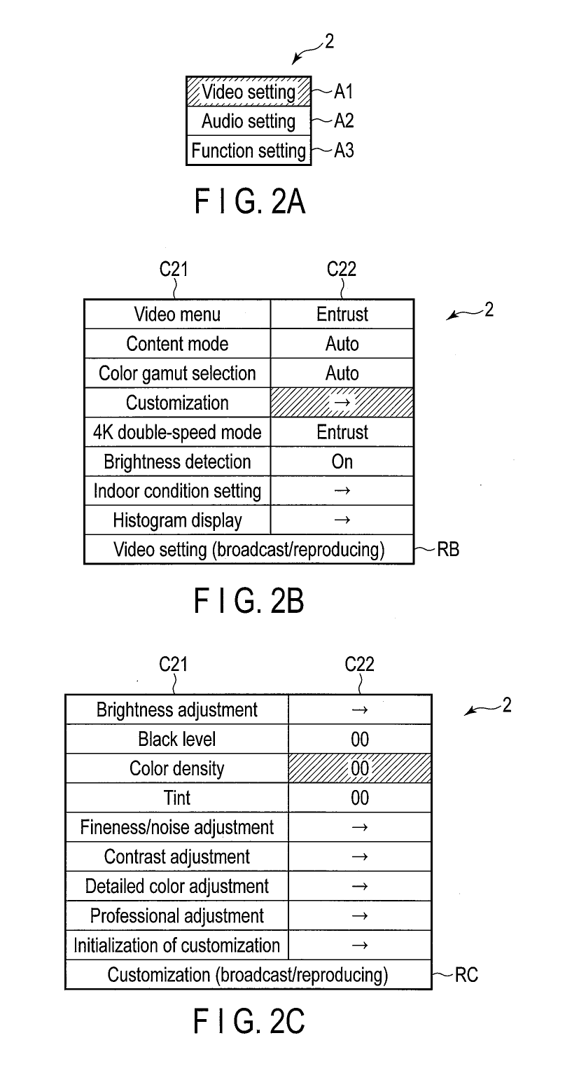

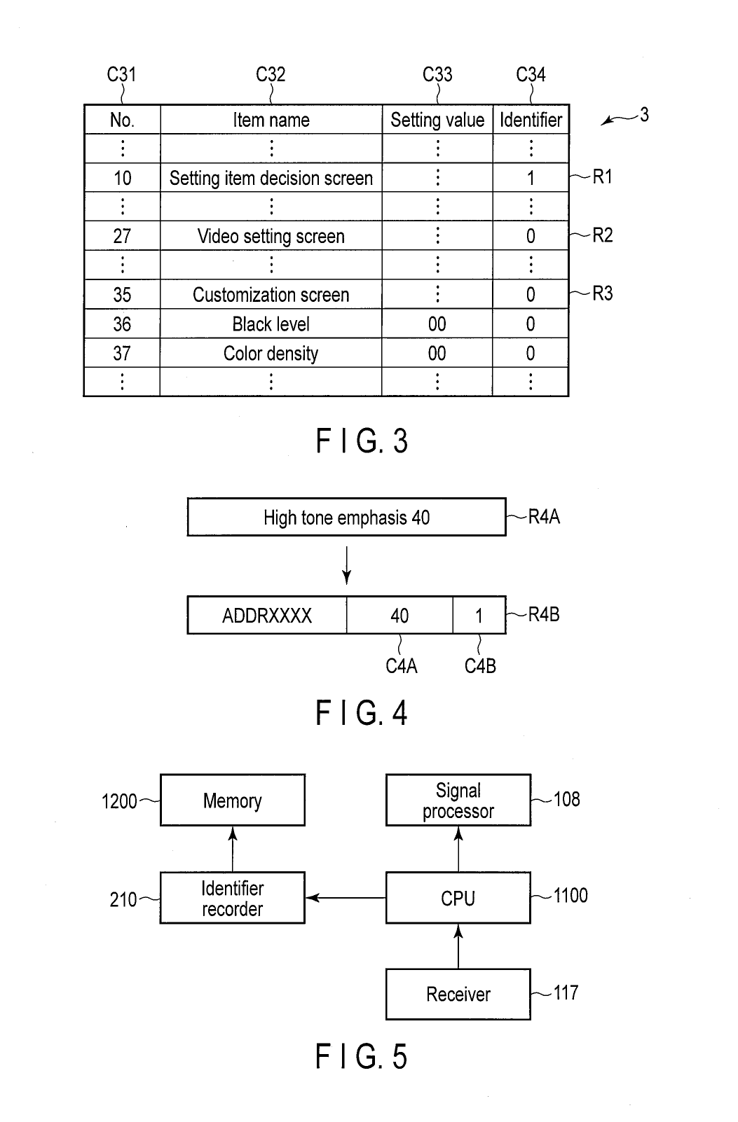

The above brief description relates to the configuration of the electronic device 1 of the embodiment. A flow from receiving the instruction to display the menu screen 2 by the receiver 117 to recording the identifier in the register in the memory 1200 by the identifier recorder 210 is hereinafter described in detail with reference to FIG. 2A, FIG. 2B, FIG. 2C and FIG. 3.

FIG. 2A, FIG. 2B and FIG. 2C show examples of the menu screen 2 for adjusting the characteristics of video, audio, etc. FIG. 3 is a table schematically showing a state of the memory in which an item number C31, an item name C32, a set value C33 and an identifier C34 of the menu screen 2 last displayed are recorded per register.

If the user wants to adjust color density of the picture, for example, a predetermined key of the remote controller 116 is pressed and the menu screen 2 shown in FIG. 2A is displayed.

The menu screen 2 in FIG. 2A is a setting item decision screen. On this screen, the user decides which of video setting A1, audio setting A2 and function setting A3 is executed.

When the setting item decision screen is displayed, the identifier recorder 210 records that the setting item decision screen is displayed by the user. More specifically, as shown in FIG. 3, an identifier field of a row R1 regarding the setting item decision screen in the register is changed from 0 to 1.

In FIG. 2A, background color of a video setting item field is reversed. For example, if the user presses an execute button in this state, the menu screen 2 is changed to a video setting screen shown in FIG. 2B.

Item names are lined up in a first column C21 of the video setting screen. A setting status per item or an arrow serving as a screen scrolling button is displayed in a second column C22 of the video setting screen. The title of the menu screen 2 is displayed in a lowest row RB of the video setting screen.

When the menu screen 2 is changed from the setting item decision screen to the video setting screen, the identifier field of a row R1 is changed from 1 to 0, and the identifier field of a row R2 regarding the video setting screen in the register is changed from 0 to 1.

In FIG. 2B, background color of a field of customization is reversed. If the user presses the execute button, the menu screen 2 is changed to a customization screen shown in FIG. 2C.

Item names are lined up in a first column C21 of the customization screen. A setting status per item or an arrow serving as a screen scrolling button is displayed in a second column C22 of the customization screen. The title of the menu screen 2 is displayed in a lowest row RC of the customization screen.

When the menu screen 2 is changed from the video setting screen to the customization screen, the identifier field of a row R2 is changed from 1 to 0, and the identifier field of a row R3 regarding the customization screen in the register is changed from 0 to 1.

FIG. 4 is a diagram schematically showing a relationship between a high tone setting screen R4A superimposed on the display and a register R4B in the memory 1200 corresponding to the high tone setting. In the electronic device 1 of the present embodiment, the menu screen to change the above set values is recorded in the register in the memory 1200 not only when the menu screen is changed, but also when an instruction to change the set value of video or audio is received.

In FIG. 4, for example, when a set value of high tone emphasis is changed from 50 to 40, a set value storage field C4A of a corresponding register R4B in the memory 1200 is changed to 40 and the identifier field C4B of the register R4B is changed to 1.

The above-described flow of the signal processing is hereinafter described again with reference to FIG. 5. FIG. 5 is a block diagram showing a flow of the signal processing from receiving the instruction to display or change the menu screen 2 by the receiver 117 to recording the identifier in the register in the memory 1200 by the identifier recorder 210.

In order to display a desired menu screen 2, for example, the user first presses a predetermined key of the remote controller 116 and provides an instruction. The receiver 117 accepts the instruction to display the menu screen 2, and the CPU 1100 receives a decoded signal regarding this instruction from the receiver 117. The CPU 1100 transmits the signal to display the menu screen 2 to the signal processor 108 in accordance with the instruction, and transmits the signal to the identifier recorder 210 to record the identifier of the menu screen 2 to be displayed in a register in the memory 1200. The identifier recorder 210 receives the signal from the CPU 1100, adds the identifier to the register in the memory 1200 and records the menu screen 2 to be displayed. The signal processing executed by the identifier recorder 210 in the above description may be executed by the CPU 1100 based on the program stored in the ROM 1101.

As described above, when the menu screen 2 is displayed or changed under the instruction accepted by the receiver 117, the identifier recorder 210 records the identifier of the displayed menu screen 2 or the changed menu screen 2 in the register in the memory 1200 in the electronic device 1 of the first embodiment. As a result, the electronic device 1 of the first embodiment can automatically record the menu screen 2 last displayed by the user without user operation. The electronic device of the first embodiment can, for example, redisplay the menu screen 2 last displayed by the user by a single key operation.

The identifier may be recorded in either the RAM 1102 or the nonvolatile memory 1103. If the identifier is recorded in the RAM 1102 and the electronic device 1 is powered off and powered on again, the menu screen 2 last displayed is not retained. Therefore, if the identifier is recorded in the RAM 1102 and, for example, a plurality of users commonly use the electronic device 1, the menu screen 2 recorded by the former user can be prevented from being erroneously redisplayed, etc. If the identifier is recorded in the nonvolatile memory 1103 and the electronic device 1 is once powered off and powered on again, the menu screen 2 last displayed is retained. Therefore, for example, when the electronic device 1 is used by only one user and the identifier is recorded in the nonvolatile memory 1103, the recorded menu screen 2 can be redisplayed, etc., even if the electronic device 1 is once powered off.

### Second Embodiment

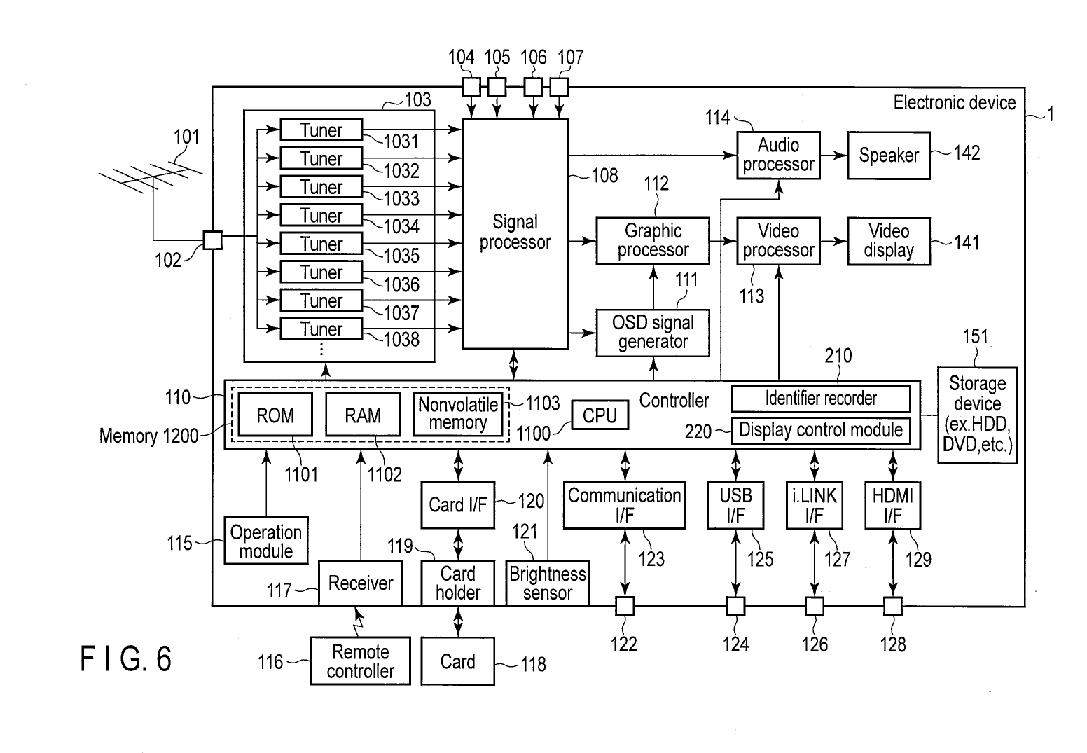

FIG. 6 is a block diagram showing a configuration of an electronic device of a second embodiment. The electronic device 1 of the second embodiment further comprises a display controller 220 in the controller 110. The display controller 220 reads the identifier recorded in the memory 1200 and transmits a signal to the CPU 1100 to display the menu screen 2 last displayed.

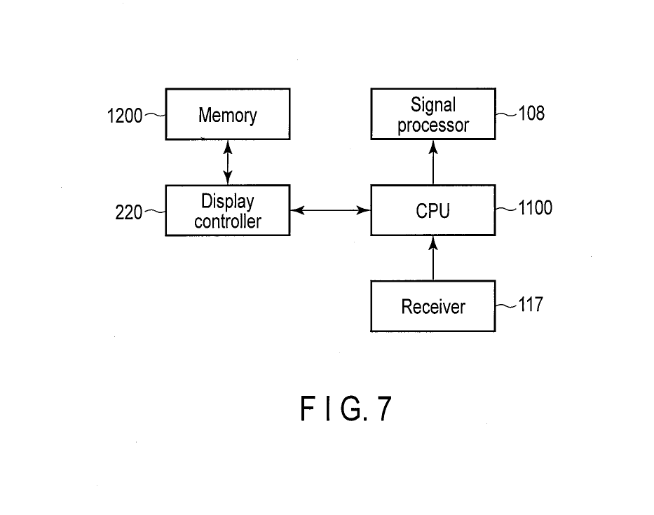

The electronic device 1 of the second embodiment executes the same signal processing as the electronic device 1 of the first embodiment until the identifier is recorded in the register in the memory 1200. A flow of the signal processing from receiving the instruction to display the menu screen 2 last displayed by the receiver 117 to displaying the menu screen 2 by the signal processor 108 is hereinafter described with reference to a block diagram of FIG. 7.

For example, in order to display the menu screen 2 last displayed, the user first executes a predetermined key operation of the remote controller 116 and provides the instruction. The predetermined key operation is, for example, an operation such as holding down the same key as the key pressed when the menu screen 2 is displayed for more than a predetermined time, or pressing this key many times within a predetermined time. That is, the predetermined key operation is to execute an operation different from a normal key operation to display or change the menu screen 2 by using the same key. Therefore, the predetermined key operation of the remote controller 116 gives an instruction (second instruction) different from display or change of the normal menu screen to the electronic device 1. The predetermined time may be two, three or five seconds, or another.

The receiver 117 accepts the instruction to display the menu screen 2 last displayed. Next, the CPU 1100 receives a decoded signal regarding this instruction from the receiver 117. In accordance with the instruction, the CPU 1100 causes the display controller 220 to read the identifier recorded in the register in the memory 1200, receives the signal from the display controller 220, and causes the signal processor 108 to display the menu screen 2 last displayed.

The signal processing executed by the display controller 220 in the above description may be executed by the CPU 1100 based on the program recorded in the ROM 1101.

As described above, in the electronic device 1 of the second embodiment, the display controller 220 reads the identifier recorded in the register in the memory 1200 under the instruction accepted by the receiver 117 and displays the menu screen 2 last displayed. As a result, the electronic device 1 of the second embodiment can not only automatically record the menu screen 2 last displayed by the user without user operation, but also redisplay the menu screen 2 last displayed by the user by a single key operation.

Therefore, according to the electronic device 1 of the second embodiment, the user does not need to redisplay the menu screen 2 by pressing the selection and execute keys many times to reset characteristics of video, audio, etc. That is, the user does not feel inconvenience when resetting characteristics of video, audio, etc.

Similarly to the first embodiment, the identifier may be recorded in either the RAM 1102 or the nonvolatile memory 1103. The signal processing executed by the display controller 220 may be executed by the CPU 1100 by the program stored in the ROM 1102.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to accept an instruction to display or change a menu screen; and
an identifier recorder configured to record, when the menu screen is displayed or changed under the instruction, an identifier of the displayed or changed menu screen.

2. The device according to claim 1, further comprising a display controller configured to read the identifier of the recorded menu screen and displays the recorded menu screen under a second instruction.

3. The device according to claim 1, wherein the instruction to change is an instruction to change a menu hierarchy.

4. The device according to claim 1, wherein the instruction to change is an instruction to change a set value of video or audio.

5. A method of processing a display screen, the method comprising:
accepting an instruction to display or change a menu screen; and
recording, when the menu screen is displayed or changed under the instruction, an identifier of the displayed or changed menu screen.

6. The method according to claim 5, further comprising reading the identifier of the recorded menu screen and displaying the recorded menu screen under a second instruction.

7. The method according to claim 5, wherein the instruction to change is an instruction to change a menu hierarchy.

8. The method according to claim 5, wherein the instruction to change is an instruction to change a set value of video or audio.
